(19) United States
(12) Patent Application Publication
(10) Pub. No.: US 2018/0039380 A1
(43) Pub. Date: Feb. 8, 2018

(54) DISPLAY APPARATUS, DISPLAY SYSTEM, AND METHOD OF CONTROLLING DISPLAY APPARATUS

(71) Applicant: SEIKO EPSON CORPORATION, Tokyo (JP)

(72) Inventor: Toshiki FUJIMORI, Chino-shi (JP)

(73) Assignee: SEIKO EPSON CORPORATION, Tokyo (JP)

(21) Appl. No.: 15/664,602

(22) Filed: Jul. 31, 2017

(30) Foreign Application Priority Data
Aug. 3, 2016 (JP) 2016-152566

(51) Int. Cl. G06F 3/042; G06T 11/20

(52) U.S. Cl. CPC G06F 3/0425; G06T 11/203

(57) ABSTRACT

A display apparatus includes: a display unit that displays a moving image based on moving image data on a display surface; an operation detection unit that detects operation of an pointer on the display surface; and a control unit that pauses the moving image displayed by the display unit in a case where the operation detection unit detects the operation of the pointer.

### CROSS-REFERENCE

The entire disclosure of Japanese Patent Application No. 2016-152566, filed Aug. 3, 2016, is expressly incorporated by reference herein.

### BACKGROUND

### 1. Technical Field

The present invention relates to a display apparatus, a display system, and a method of controlling the display apparatus.

### 2. Related Art

In the related art, an apparatus is known that detects operation of an pointer on a display surface on which an image is displayed and causes an image, such as a letter or a figure, which corresponds to the detected operation, to be displayed on the display surface (for example, refer to JP-A-2012-53603).

JP-A-2012-53603 discloses an information display system in which a trace of a pointing device on a screen is detected and an image that is based on the detected trace, which is detected in a projection image, is drawn.

However, in a state where a moving image is displayed on a display surface, in a case where writing relating to contents of a moving image displayed is performed using the pointer, because an image that constitutes the moving image changes, there is a need to perform the writing after temporarily stopping the moving image.

For this reason, in a case where the writing is frequently performed using an pointer, an operation of causing the moving image to be temporarily stopped each time the writing is performed, and an operation of causing reproduction of the moving image that is temporarily stopped to be resumed have to be performed, and there is a problem in that the operation is frequently performed.

### SUMMARY

An advantage of some aspects of the invention is that in a display apparatus, a display system, and a method of controlling the display apparatus, operability in a case where an operation is performed on a moving image that is displayed on a display surface using an pointer is elevated.

A display apparatus according to an aspect of the invention includes: a display unit that displays a moving image based on moving image data on a display surface; an operation detection unit that detects operation of an pointer on the display surface; and a control unit that pauses the moving image displayed by the display unit, in a case where the operation detection unit detects the operation of the pointer.

According to the aspect of the invention, when the operation of the pointer is detected, the moving image is paused. Therefore, operability in a case where the operation is performed on the moving image that is displayed on the display surface using the pointer can be elevated.

In the display apparatus according to the aspect of the invention, the control unit may pause the moving image and causes the display unit to display a still image, in a case where the operation detection unit detects the operation of the pointer, in a state where the display unit displays the moving image based on the moving image data.

According to the aspect of the invention with this configuration, when the operation of the pointer is detected, the moving image is paused and the still image is displayed. Therefore, with the operation of the pointer, the moving image can be paused.

In the display apparatus according to the aspect of the invention, the control unit may generate a still image that constitutes the moving image that is being displayed by the display unit, and may cause the display unit to display the generated still image, in the case where the operation detection unit detects the operation of the pointer.

According to the aspect of the invention with this configuration, when the operation of the pointer is detected, the still image that constitutes the moving image that is being displayed by the display unit is generated, and the generated still image is displayed by the display unit. Therefore, the still image that constitutes the moving image which is displayed on the display surface can be caused to be displayed.

The display apparatus according to the aspect of the invention may further include an interface unit that performs communication with an external apparatus which supplies the moving image data to the display apparatus, in which the control unit may transmit an instruction to pause the moving image data, via the interface unit, in the case where the operation detection unit detects the operation of the pointer.

According to the aspect of the invention with this configuration, when the operation of the pointer is detected, the instruction to pause the moving image data is transmitted by the interface unit. Therefore, the external apparatus can be instructed to pause the moving image data.

In the display apparatus according to the aspect of invention, the control unit may generate a still image that constitutes the moving image which is being displayed by the display unit and may cause the display unit to display the generated still image, in a case where a response to the instruction to pause the moving image data is not received by the interface from the external apparatus.

According to the aspect of the invention with this configuration, the still image that constitutes the moving image is generated and the generated still image is displayed by the display unit, in a case where the response to the instruction to pause the moving image data cannot be received in the interface unit. Therefore, although the instruction to pause the image data is provided via the interface unit, in a case where the response cannot be received in the interface unit, the still image that constitutes the moving image can be caused to be generated and the generated still image can be displayed.

In the display apparatus according to the aspect of the invention, the control unit may generate a drawing image based on the operation of the pointer that is detected by the operation detection unit, and may cause the display unit to display the generated drawing image.

According to the aspect of the invention with this configuration, the drawing image is generated based on the operation of the pointer that is detected by the operation detection unit, and the generated drawing image is displayed by the display unit. Therefore, the drawing image can be displayed by the display unit with the operation of the pointer.

In the display apparatus according to the aspect of the invention, a detection area may be set on the display surface, the operation of the pointer is detected on the detection area, and the control unit may generate the drawing image based on the operation of the pointer in the detection area, which is detected by the operation detection unit, and may cause the display unit to display the generated drawing image.

According to the aspect of the invention with this configuration, the operation of the pointer, which is performed in the detection area is detected, the drawing image that is based on the detected operation of the pointer is generated, and the generated drawing image is displayed on the display surface. Therefore, in a case where the operation of the pointer is performed in the detection area, the drawing image that is based on the operation of the pointer is displayed on the display surface, and in a case where the operation of the pointer is performed in an area other than the detection area, another operation can be performed using the pointer without causing the drawing image to be displayed on the display surface.

In the display apparatus according to the aspect of the invention, the control unit may determine whether to pause the moving image, based on an operation position of the pointer that is detected by the operation detection unit.

According to the aspect of the invention with this configuration, based on the operation position of the pointer, it is determined whether to pause the moving image. Therefore, the operation position of the pointer is changed, and thus switching can take place between performing the operation of the pointer by pausing the moving image, and performing another operation using the pointer without pausing the moving image.

In the display apparatus according to the aspect of the invention, the control unit may pause the moving image, in a case where the operation position of the pointer that is detected by the operation detection unit is located within a predetermined range that is set in an image area of the display surface on which the moving image is displayed.

According to the aspect of the invention with this configuration, the operation of the pointer is performed within the predetermined range that is set in the image area of the display surface on which the moving image is displayed, and thus the moving image can be paused. Therefore, the operation position in which the operation is performed using the pointer is changed, and thus the moving image can be paused, or another operation can be performed using the pointer without pausing the moving image.

A display system according to an aspect of the invention includes: a supply apparatus that supplies a moving image data; and a display apparatus that displays a moving image based on the moving image data supplied from the supply apparatus, in which the display apparatus includes a display unit that displays a moving image based on the moving image data on a display surface, an operation detection unit that detects operation of an pointer on the display surface; and a control unit that pauses the moving image displayed by the display unit in a case where the operation detection unit detects the operation of the pointer.

According to the aspect of the invention, when the operation of the pointer is detected, the moving image is paused. Therefore, operability in a case where the operation is performed on the moving image that is displayed on the display surface using the pointer can be elevated.

A method of controlling a display apparatus according to an aspect of the invention is a method of controlling a display apparatus that includes a display unit which displays an image on a display surface, the method including: detecting operation of an pointer on the display surface, in a state where a moving image based on the moving image data is displayed on the display surface, and pausing the moving image displayed by the display unit, in a case where the operation of the pointer is detected.

According to the aspect of invention, when the operation of the pointer is detected, the moving image is paused. Therefore, operability in a case where the operation is performed on the moving image that is displayed on the display surface using the pointer can be elevated.

### BRIEF DESCRIPTION OF THE DRAWINGS

The invention will be described with reference to the accompanying drawings, wherein like numbers reference like elements.

FIG. 1 is a constitutional diagram illustrating a systematic configuration of a display system according to a first embodiment.

FIG. 2 is a constitutional diagram illustrating a configuration of a projector.

FIG. 3 is a diagram illustrating a captured-image data.

FIG. 4 is a flowchart illustrating operation of the projector.

FIG. 5 is a constitutional diagram illustrating a systematic configuration of a display system according to a second embodiment.

### DESCRIPTION OF EXEMPLARY EMBODIMENTS

Embodiments of the invention are described below referring to the accompanying drawings.

### First Embodiment

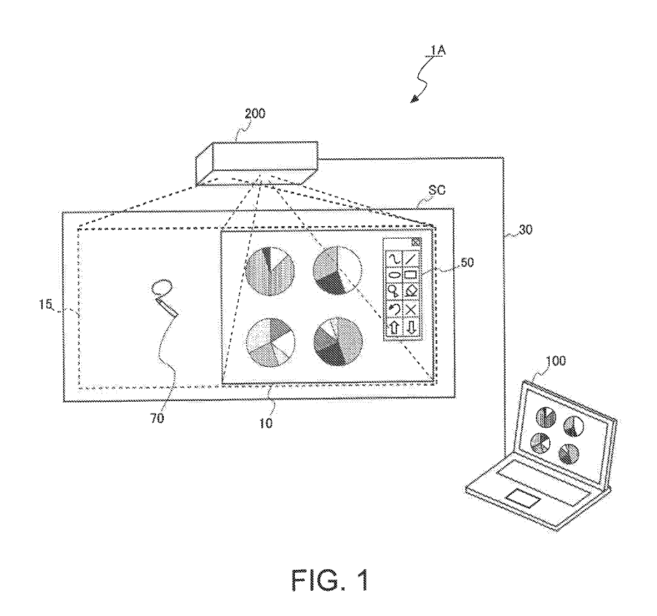

FIG. 1 is a configurational diagram of a systematic configuration of a display system 1A according to a first embodiment.

The display system 1A includes an image supply apparatus 100 that supplies an image signal, and a projector 200 that projects an image, such as a still image or a moving image, onto a projection target, based on the image signal that is supplied from the image supply apparatus 100. The image supply apparatus 100 and the projector 200 are connected to each other with a cable 30. The image supply apparatus 100 is equivalent to an “external apparatus” according to the invention. Furthermore, the projector 200 is equivalent to a “display apparatus” according to the invention.

As the image supply apparatus 100, for example, a note-type PC (a personal computer), a desktop-type PC, a tablet terminal, a smartphone, a personal digital assistant (PDA), or the like can be used. Furthermore, as the image supply apparatus 100, a video reproduction apparatus, a digital versatile disk (DVD) player, a Blu-ray disc player, a TV tuner apparatus, and a set-top box of cable television (CATV), a video game machine, or the like can be used.

In the present embodiment, moving image data and a synchronization signal are included in the image signal that is supplied to the projector 200 by the image supply apparatus 100. The moving image data is data that results for coding a plurality of pieces of frame image data that are arranged one after another in a time sequence, in compliance with a compression scheme, such as MPEG, WMV, or Motion JPEG. The frame image data is image data in one frame that constitutes the moving image data. Furthermore, the moving image data may be a slide animation that is created by presentation software. Furthermore, the synchronization signal is a signal necessary for control of reproduction of the moving image data, and a horizontal synchronization signal or a vertical synchronization signal is included in the synchronization signal.

It is noted that in the present embodiment, a case where the moving image data and the synchronization signal are included in the image signal which is supplied by the image supply apparatus 100 is described, but that moving image data, audio data and the synchronization signal may be included in the image signal. Furthermore, the image supply apparatus 100 can supply the image signal that includes still image data, to the projector 200.

The projector 200 extracts the moving image data and the synchronization signal from the image signal that is received through the cable 30, processes the moving image data according to a timing that is stipulated by the synchronization signal, and projects the moving image that is based on the processed moving image data, onto the projection target. The projector 200 according to the present embodiment is installed above a screen SC as the projection target, and projects the moving image onto the screen SC that is installed below. The screen SC is equivalent to a “display surface” according to the invention. In the present embodiment, a case where the projection target is the screen SC is taken as an example for description, but although the projection target is one that has a flat surface, such as an internal wall of a building, this poses no problem. Furthermore, the projection target may be an external wall of the building.

The projector 200 projects an image onto the screen SC. An area on the screen SC on which the image is projected refers to a projection area (an image area) 10. It is also possible that the projector 200 projects an image onto a whole surface of the screen SC as the projection area 10. It is also possible that the projector 200 projects an image onto one area of the screen SC as the projection area 10. In FIG. 1, a case is illustrated where an image is projected onto one area of the screen SC as the projection area 10.

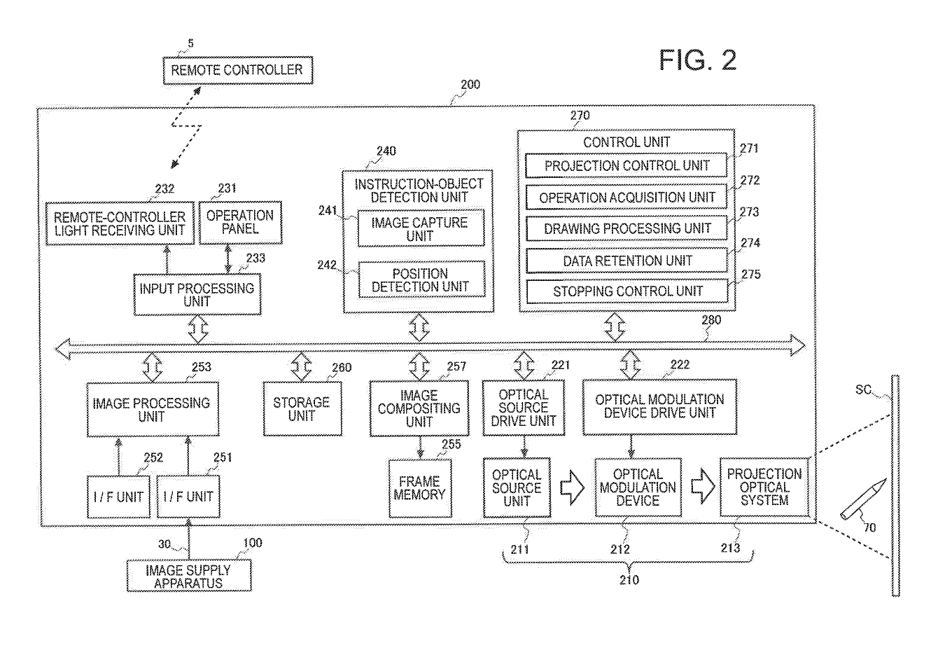

The projector 200 detects operation of an pointer 70 on the screen SC. The projector 200 detects the operation of the pointer 70, and performs processing that corresponds to the detected operation. The projector 200 includes an pointer detection unit 240 (refer to FIG. 2) that captures an image of a screen SC direction, and detects the operation of the pointer 70 based on captured-image data that is generated by an pointer detection unit 240. According to the operation of the pointer 70, for example, drawing processing that draws an image, such as a letter, a symbol, or a figure, on the screen SC is included in processing that is performable by the projector 200. Furthermore, in a state where a menu image 50 is displayed on the screen SC, when an icon for the menu image 50 is selected with the pointer 70, processing that corresponds to the selected icon is performed. Icons that are displayed on the menu image 50, for example, include an icon for removing an image that is drawn with the drawing processing, an icon for selecting the thickness of a line that is drawn with the drawing processing, an icon for retaining an image that is drawn with the drawing processing, an icon for causing reproduction of a moving image that is temporarily stopped to be resumed, and the like.

Furthermore, in the present embodiment, a case where an electronic pencil is used as the pointer 70 is described but the pointer 70 may be a user's finger.

FIG. 2 is a configuration of the projector 200.

The projector 200 includes a plurality of interface units (hereinafter referred to as an I/F unit for short) 251 and 252. Each of the I/F units 251 and 252 includes a connector that connects to the cable 30 and an I/F circuit (an illustration of any one of which is omitted). The image signal that is supplied from the image supply apparatus 100 which is connected to the cable 30 is input through each of the I/F units 251 and 252. The I/F units 251 and 252 each extract the moving image data and the synchronization signal from the image signal that is input, and output the moving image data and the synchronization signal, which are extracted, to an image processing unit 253.

The interface that is included in each of the I/F units 251 and 252, for example, may be an interface for the image data, such as HDMI (a registered trademark), MHL (a registered trademark), or a display port.

Furthermore, in a case where the projector 200 is configured to be capable of reproducing the audio data, the I/F units 251 and 252 each may include an interface for inputting the moving image data and an interface for inputting the audio data. For example, the projector 200 includes a VGA terminal, such as a D-Sub connector as a connector for reception of the moving image data, or a digital visual interface (DVI) terminal, and can be assumed to be configured to include a composite terminal as the connector for reception of the audio data. The I/F units 251 and 252 each include a VGA terminal as a connector, and in a case where an analog image signal is input through the VGA terminal, may be configured to convert the analog image signal into the moving image data, with an A/D conversion circuit that is not illustrated, and to output the resulting signal to the image processing unit 253. Furthermore, the interface that is included in each of the I/F interface units 251 and 252 may be an interface for data communication in compliance with Ethernet (a registered trademark), IEEE 1394, USB, or RS-232C.

Furthermore, the image supply apparatus 100 and the projector 200 may be connected to each other in a wireless manner. In this case, as an interface, for example, Miracast (a registered trademark), Wireless HD (a registered trademark), Wireless Display (Widi), AirPlay (a registered trademark), wireless Home Digital Interface (WHDI), or the like can be used.

In the present embodiment, the I/F unit 251, for example, is defined as including an interface through which transmission of the image signal in compliance with HDMI or the like and transmission and reception of a control signal are possible. The cable 30 that is connected to the I/F unit 251 includes a data line that is used for transmission and reception of the image signal, and a consumer electronics control line (CEC) line that is used for the transmission and reception of the control signal.

Furthermore, an interface of the I/F unit 252 is defined as an interface through which only the transmission of the image signal is possible. That is, in a case where the I/F unit 252 is connected to the image supply apparatus 100, the I/F unit 252 is defined as an interface through which the control signal cannot be transmitted from the projector 200 to the image supply apparatus 100.

The projector 200 includes a display unit 210 that performs formation of an optical image and causes the image to be projected onto the screen SC.

The display unit 210 includes an optical source unit 211, an optical modulation device 212, and a projection optical system 213. The display unit 210 and the image processing unit 253 that will be described below is equivalent to the “display unit” according to the invention.

The optical source unit 211 includes an optical source that is configured as a xenon lamp, an extra-high pressure mercury lamp, a light emitting diode (LED), or a laser optical source. Furthermore, the optical source unit 211 may include a reflector and an auxiliary reflector that lead light which is emitted by the optical source, to the optical modulation device 212. Additionally, the optical source unit 211 may include a lens group that enhances optical properties of projection light, a polarization plate, a modulation element that causes an amount of the light that is emitted by the optical source to be reduced on a path that leads to the optical modulation device 212, and the like, (an illustration of any one of which is are mitted).

The optical source unit 211 is driven by the optical source drive unit 221. The optical source drive unit 221 is connected to an internal bus 280. The optical source drive unit 221 causes an optical source of the optical source unit 211 to be powered on and off under the control of the control unit 270 in order to emit light and stop emitting light.

The optical modulation device 212, for example, includes three liquid crystal panels that correspond to three primary colors, Red, Green, and Blue. The light that is emitted by the optical source unit 211 is separated into three beams of RGB-colored light, which are incident on corresponding liquid crystal panels, respectively. The three liquid crystal panels are liquid crystal panels that are of a light transmission type, and modulate light that passes through and generates image light. The beams of image light that are modulated by passing through the liquid crystal panels, respectively, are composited by an optical system for compositing, such as a cross dichroic prism, and light that results from the compositing is emitted to the projection optical system 213.

The optical modulation device 212 is driven by the optical modulation device drive unit 222. The optical modulation device drive unit 222 is connected to the internal bus 280.

The optical modulation device drive unit 222 generates RGB display image signals based on display image data that is input from an image compositing unit 257. The optical modulation device drive unit 222 drives corresponding liquid crystal panels based on an R display image signal, a G display image signal, and a B display image signal, which are generated, and draws an image at each liquid crystal panel.

The projection optical system 213 includes a lens group through which the image light that is modulated by the optical modulation device 212 is projected toward the direction of the screen SC and which causes an image to be formed on the screen SC. Furthermore, the projection optical system 213 may include a zoom mechanism that causes the image which is projected onto the screen SC to be enlarged and reduced, or a focus adjustment mechanism that performs focus adjustment.

The projector 200 includes an operation panel 231 and an input processing unit 233. The input processing unit 233 is connected to the internal bus 280.

Various operation keys or display screens that are configured in the liquid crystal panel are provided on the operation panel 231 that functions as a user interface.

When an operation key on the operation panel 231 is operated, the input processing unit 233 outputs an operation signal that corresponds to the key that is operated, to the control unit 270. Furthermore, a touch sensor that detects contact to the operation panel 231 is integrally formed on the operation panel 231 in a superimposed manner. The input processing unit 233 detects a position of the operation panel 231 with which the user's finger or the like comes into contact, as an input position, and outputs the operation signal that corresponds to the detected input position, to the control unit 270. Additionally, the input processing unit 233 causes various screens to be displayed on the operation panel 231 based on the control signal that is input from the control unit 270.

Furthermore, the projector 200 has a remote controller 5 that is used by a user. The remote controller 5 includes various buttons, and transmits an infrared signal, corresponding to operation of each of these buttons. A remote-controller light receiving unit 232 that receives light carrying the infrared signal that is emitted by the remote controller 5 is positioned in a main body of the projector 200. The remote-controller light receiving unit 232 receives the light carrying the infrared signal that is transmitted from the remote controller 5. The input processing unit 233 decodes the infrared signal that is carried by the light which is received by the remote-controller light receiving unit 232, generates the operation signal indicating details of the operation in the remote controller 5, and outputs the generated operation signal to the control unit 270.

The projector 200 includes the pointer detection unit 240 that is connected to the internal bus 280. The pointer detection unit 240 includes an image capture unit 241 and a position detection unit 242, and detects the operation of the pointer 70 on the screen SC. The pointer detection unit 240 is equivalent to an “operation detection unit” according to the invention.

At this point, a configuration of the pointer 70 is described.

Holding the pointer 70 in his/her hand, the user performs an operation in such a manner that a tip portion of the pointer 70 comes into contact with the screen SC. An operation switch (whose illustration is omitted) that emits infrared light in a case where the control switch is pressed is built into the tip portion of the pointer 70. When an operation of pressing the tip portion of the pointer 70 against a wall or the screen SC is performed, the operation switch is on, and infrared light is emitted.

The image capture unit 241 can perform both of image capture that uses infrared light and image capture that uses visible light. Specifically, a configuration can be assumed to be employed that includes an imaging element for infrared light that image-captures infrared light, an imaging element for visible light that image-captures visible light, an interface circuit of the imaging element for infrared light, and an interface circuit of the imaging element for visible light. Furthermore, a configuration may be employed that performs the image capture for visible light and the image capture for infrared light using one imaging element. Furthermore, for example, in a case where a filter that blocks one portion of light that is incident on the imaging element is provided in the image capture unit 241, and where the imaging element is caused to receive infrared light, a filter that mainly allows light in infrared area to pass through may be positioned before the imaging element. Furthermore, the imaging element may be any one of CCD and CMOS, and other elements may be used as the imaging elements.

When it comes to a direction and a range (an angle of view) in which the image capture unit 241 performs the image capture when performing the image capture using infrared light, such a direction faces the same direction or approximately the same direction as the projection optical system 213, and such a range covers a range in which the projection optical system 213 projects an image onto the screen SC. In the same manner, when it comes to a direction and a range in which the image capture unit 241 performs the image capture when performing the image capture using visible light, such a direction faces the same direction or approximately the same direction as the projection optical system 213, and such a range covers a range in which the projection optical system 213 projects an image onto the screen SC. The image capture unit 241 outputs the captured-image data that results from performing the image capture using infrared light, and the captured-image data that results from performing the image capture using visible light, to the position detection unit 242.

The position detection unit 242 detects the operation and an operation position of the pointer 70. The position detection unit 242 detects the emission of light by the tip portion of the pointer 70 from the captured-image data that results from performing the image capture using infrared light, and thus detects a position of the tip portion of the pointer 70. The position detection unit 242 generates coordinate information indicating the detected position of the tip portion of the pointer 70, and outputs the generated coordinate information, as coordinate information indicating the operation position of the pointer 70, to the control unit 270. This coordinate information is coordinates that result from the captured-image data that is generated by the image capture unit 241.

Furthermore, the position detection unit 242 detects a projection area 10 (the display position) from the captured-image data that results from the image capture unit 241 performing the image capture using visible light.

A method of detecting the projection area 10 is described. The control unit 270 that will be described below controls the display unit 210 and thus causes an image in a predetermined pattern to be projected onto the screen SC. Next, the control unit 270 controls the pointer detection unit 240 and thus causes the image capture unit 241 to generate the visible-light captured-image data. The position detection unit 242 detects the image in the predetermined pattern from the visible-light captured-image data that is generated by the image capture unit 241, and thus detects the projection area 10. The position detection unit 242 outputs information indicating a range of the detected projection area 10 to the control unit 270. It is noted that when the image in the predetermined pattern that is projected on the screen SC in order to detect the projection area 10, for example, is an image with which it is possible to detect the range of the projection area 10 from the captured-image data, such as a block-colored image, this poses no problem.

The projector 200 includes an image processing system. This image processing system is configured to primarily include the control unit 270 that controls the entire projector 200 in an integrated manner, and additionally includes a storage unit 260, the image processing unit 253, the image compositing unit 257, and a frame memory 255. The units that constitute the image processing system are connected to each other through the internal bus 280 in a manner that enables data communication. The image processing unit 253 is equivalent to the “display unit” according to the invention.

The image processing unit 253 performs processing in such a manner that a plurality of pieces of frame image data which constitute the moving image data are input from the I/F unit 251 and that the pieces of frame image data that are input are loaded onto the frame memory 255. Furthermore, the synchronization signal is input into the image processing unit 253 from the I/F unit 251, and the image processing unit 253 processes the frame image data in accordance with the synchronization signal that is input. For example, resolution conversion (scaling) processing or resize processing, shape correction processing such as distortion correction, digital zoom processing, color correction processing, luminance correction processing, and the like are included in the processing that is performed by the image processing unit 253. The image processing unit 253 performs processing that is designated by the control unit 270, and when necessary, performs processing using a parameter that is input from the control unit 270. Furthermore, of course, it is also possible that the image processing unit 253 performs a plurality of processing operations in combination, among the processing operations described above. The image processing unit 253 outputs the frame image data whose processing is ended to the image compositing unit 257.

Furthermore, not only does data that is processed by the image processing unit 253 include the moving image data that is input from the I/F unit 251, but also includes moving image data that is stored in advance in the storage unit 260. That is, when the projector 200 is powered on, the moving image data that is stored in the storage unit 260 is included as well.

The image compositing unit 257 loads the frame image data that is input from the image processing unit 253, to the frame memory 255. Furthermore, in a case where drawing data (drawing image) that will be described below is input from the control unit 270, under the control of the control unit 270, the image compositing unit 257 superimposes the acquired drawing data onto the frame image data that is deployed onto the frame memory 255, and generates the display image data. The drawing data will be described in detail below. The image compositing unit 257 reads the generated display image data from the frame memory 255, and outputs the generated display image data, which is read, to the optical modulation device drive unit 222. Furthermore, in a case where the drawing data is not input from the control unit 270, the image compositing unit 257 reads the frame image data that is processed by the image processing unit 253 and is loaded by the frame memory 255, and outputs the frame image data, which is read, as the display image data, to the optical modulation device drive unit 222.

The storage unit 260, for example, is an auxiliary storage device such as a hard disk device. The storage unit 260 may be replaced with a flash memory or a compact disc (CD), which is capable of storing a large volume of information, or an optical disc, such as a digital versatile disc (DVD) or a Blu-Ray (a registered trademark) disc (BD). An application program that is executed by the control unit 270 or various pieces of data are stored in the storage unit 260.

Furthermore, the information indicating the range of the projection area 10 that is detected by the pointer detection unit 240 is stored in the storage unit 260.

The control unit 270 includes a CPU, a ROM, and a RAM (an illustration of any one which is omitted), as pieces of hardware. The ROM is a non-volatile storage device, such as a flash ROM, and a control program or data is stored in the ROM. The RAM constitutes a work area for the CPU. The CPU loads the control program, which is read from the ROM, onto the RAM, and executes the loaded control program and thus controls each unit of the projector 200.

The control unit 270 includes a projection control unit 271, an operation acquisition unit 272, a drawing processing unit 273, a data retention unit 274, and a stop control unit 275, as functional blocks. These functional blocks are realized by executing the control program that is loaded onto the RAM. The stop control unit 275 is equivalent to the “control unit” according to the invention.

The projection control unit 271 controls each unit of the projector 200, and thus controls the projection of the moving image onto the screen SC.

Specifically, the projection control unit 271 controls the image processing unit 253, and thus causes the frame image data, which is input, to be processed. On this occasion, the projection control unit 271 may read a parameter necessary for the processing by the image processing unit 253, from the storage unit 260, and may output the parameter, which is read, to the image processing unit 253. Furthermore, the projection control unit 271 controls the image compositing unit 257, and thus causes the image compositing unit 257 to perform processing that composites the frame image data and the drawing data. Furthermore, the projection control unit 271 controls the optical modulation device drive unit 222, and thus causes an image to be drawn on the liquid crystal panel of the optical modulation device 212. Additionally, the projection control unit 271 controls the optical source drive unit 221, and thus causes the optical source of the optical source unit 211 to be powered on, and causes luminance of the optical source to be adjusted. Accordingly, image light that the optical modulation device 212 modulates with the emission of light by the optical source is projected onto the screen SC by the projection optical system 213.

The operation acquisition unit 272 performs coordinate conversion of coordinates that are indicated by the coordinate information that is input from the pointer detection unit 240. The coordinate information that is output to the control unit 270 by the pointer detection unit 240 is coordinates that result from the captured-image data that is generated by the image capture unit 241. The operation acquisition unit 272 converts the coordinates that are indicated by the coordinate information which is input from the pointer detection unit 240, into coordinates on the frame memory 255. That is, the operation acquisition unit 272 converts the coordinates that are input from the pointer detection unit 240, into the coordinates on the frame memory 255, which are coordinates for the drawing processing unit 273 to perform drawing on the frame memory 255. The operation acquisition unit 272 outputs the coordinate information that results from the coordinate-conversion, to the drawing processing unit 273.

The drawing processing unit 273 detects a trace of the operation of the pointer 70 by connecting together coordinates of operation positions that are indicated by pieces of coordinate information that are input from the operation acquisition unit 272. The drawing processing unit 273 generates the drawing data in accordance with the detected trace. This drawing data, for example, is data indicating a letter or a symbol, a line, a figure, or the like. The drawing processing unit 273 outputs the generated drawing data to the image compositing unit 257.

Furthermore, in a case where the coordinates that are indicated by the coordinate information which is input from the operation acquisition unit 272 indicates the same position or almost the same position consecutively a plurality of times, the drawing processing unit 273 determines that input for an operation of selecting the detected operation position is received. In this case, the drawing processing unit 273, for example, determines that this operation is an operation of selecting the icon for the menu image 50 that is displayed on the screen SC, and thus receives input for an operation of selecting the icon that is displayed at the detected coordinates.

In a case where the pointer 70 or the operation panel 231 is operated and where an instruction that retains data is received, the data retention unit 274 acquires the display image data that is loaded onto the frame memory 255 and causes the acquired display image data to be stored in the storage unit 260.

When the operation of the pointer 70 on the screen SC is detected by the pointer detection unit 240, the stop control unit 275 pause the moving image that is being projected onto the screen SC, and causes the still image to be projected.

First, when the image supply apparatus 100 is connected, the stop control unit 275 determines whether the interface that is connected to this image supply apparatus 100 is the I/F unit 251 through which the transmission and reception of the control signal is possible or is the I/F unit 252 through which the control signal cannot be transmitted and received. That is, the stop control unit 275 transmits the control signal to the image supply apparatus 100, and determines whether or not the moving image data can be paused. The stop control unit 275 stores a result of the determination in the RAM.

Next, when the image signal starts to be supplied from the connected image supply apparatus 100, the projector 200 receives this image signal from the I/F unit 251 or 252, and extracts the moving image data and the synchronization signal from the received image signal. Furthermore, the projector 200 causes the image processing unit 253 or the like to process the extracted moving image data, and causes the moving image, which is based on the moving image data, to be projected onto the screen SC.

When the operation of the pointer 70 on the screen SC is detected by the pointer detection unit 240, the stop control unit 275 causes the moving image that is being projected onto the screen SC to be stopped, and causes the still image to be projected on the screen SC.

When the operation of the pointer 70 is detected, the stop control unit 275 makes a connection to the image supply apparatus 100 referring to the information that is stored in the RAM, and determines whether or not the I/F unit 251 is used. In a case where it is determined that the I/F unit 251 through which the transmission and reception of the control signal is possible is used for the connection to the image supply apparatus 100, the stop control unit 275 transmits the control signal to the image supply apparatus 100. This control signal is a control signal that requests the image supply apparatus 100 to stop the supply of the image signal.

In a case where an acknowledgement indicating a response to the control signal is received from the image supply apparatus 100 within a predetermined time, the stop control unit 275 determines that the supply of the image signal from the image supply apparatus 100 is stopped. When the supply of the image signal from the image supply apparatus 100 is stopped, new frame image data is not input into the image processing unit 253. For this reason, an image (a still image) that is based on the frame image data that has been loaded onto the frame memory 255 is projected, as a capture image, onto the screen SC, without the new frame image data being loaded onto the frame memory 255.

When the acknowledgement is received, the stop control unit 275 instructs the drawing processing unit 273 to generate the drawing data. The drawing processing unit 273 that is instructed to generate the drawing data generates the drawing data that corresponds to the operation position of the pointer 70, which is detected by the pointer detection unit 240, and the image compositing unit 257 superimposes this drawing data onto the frame image data that is loaded onto the frame memory 255. With these processing operations, an image (hereinafter referred to as the drawing image), such as a letter or symbol, or a figure, which is in accordance with the operation of the pointer 70 is projected onto the screen SC.

Furthermore, in a case where it is determined that the I/F unit 252 is used for the connection to the image supply apparatus 100, or in a case where the acknowledgement cannot be received within a predetermined time after the transmission of the control signal, the stop control unit 275 performs freeze processing and thus generates the still image that constitutes the moving image.

The freeze processing is processing that causes the image processing unit 253 to stop the processing in such a manner that new frame image data is not loaded onto the frame memory 255. While the freeze processing is performed and the image processing unit 253 stops the processing, the image signal that is supplied from the image supply apparatus 100 is discarded without being processed. While the freeze processing is performed, an image (a still image) that is based on the frame image data that has been loaded onto the frame memory 255 is projected, as the capture image, onto the screen SC, without the frame image data, which constitutes the moving image data that is supplied, being newly loaded onto the frame memory 255.

Furthermore, while the freeze processing is performed, only in a case where the drawing data is input from the drawing processing unit 273, the image compositing unit 257 causes the drawing data, which is input, to be superimposed onto the frame image data that is loaded onto the frame memory 255, and then outputs the resulting data to the optical modulation device drive unit 222.

Furthermore, in a case where an operation detection area (a detection area) 15 is set and where the operation of the pointer 70 is detected on this operation detection area 15, the stop control unit 275 pauses the moving image.

This operation detection area 15 is set based on the projection area 10. In the present embodiment, the operation detection area 15 includes the entire projection area 10 and is set to be in a wider range than the projection area 10, but the operation detection area 15 may be set in such a manner that only one portion of the projection area 10 is included, and may be set in such a manner that the operation detection area 15 is not superimposed on the projection area 10. Furthermore, a full range where the image capture is performed may be set as the operation detection area 15, in the captured-image data that is generated by the image capture unit 241.

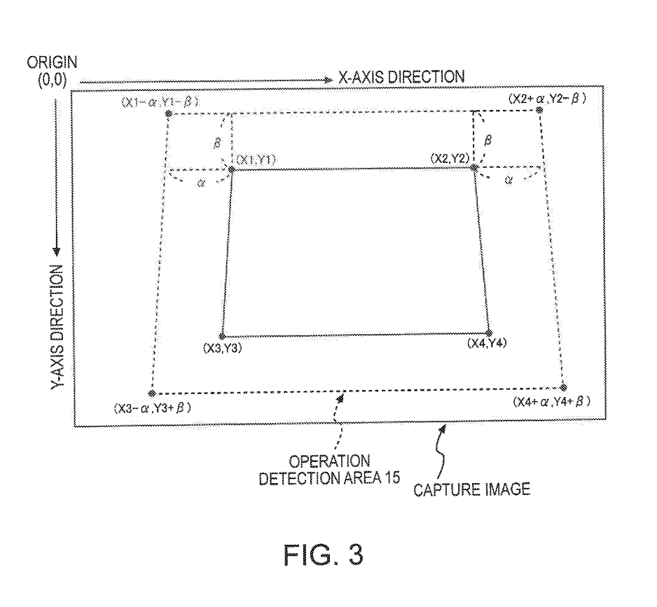

The stop control unit 275 sets an operation detection area 15 based on the projection area 10 of the moving image that is projected onto the screen SC. A method of setting the operation detection area 15 is described with reference to FIG. 3.

FIG. 3 illustrates the visible-light captured-image data that is generated by the image capture unit 241.

The position detection unit 242, for example, detects the image data in a predetermined pattern from the captured-image data, and thus detects the projection area 10. In an example that is illustrated in FIG. 3, the position detection unit 242 detects a range that is surrounded by four apexes (X1, Y1), (X2, Y2), (X3, Y3), and (X4, Y4), as the projection area 10. It is noted that in FIG. 3, a coordinate system is illustrated in which the horizontal direction and the vertical direction are set to be the X-axis direction and the Y-axis direction, respectively, with the uppermost leftmost point of the captured image as an origin.

The stop control unit 275 acquires coordinates of the four apexes (X1, Y1), (X2, Y2), (X3, Y3), and (X4, Y4) from the storage unit 260, adds or subtracts a value that is set in advance to and from each of the acquired coordinates, and sets the operation detection area 15.

In FIG. 3, a case is illustrated where the X-axis direction α and the Y-axis direction β are added or subtracted to and from the coordinates of the four apexes that expresses the projection area 10, and thus the operation detection area 15 is detected. For example, in a case where the projection area 10 is expressed by (X1, Y1), (X2, Y2), (X3, Y3), and (X4, Y4), the operation detection area 15 is in a range of areas that result from connecting four apexes (X1−α, Y1−β), (X2+α, Y2−β), (X3−α, Y3+β), and (X4+α, Y4+β) with straight lines.

In a case where the operation of the pointer 70 that is detected by the pointer detection unit 240 is operation that is performed within the operation detection area 15, the stop control unit 275 instructs the image processing unit 253 to stop performing processing. Therefore, the performing of the operation of the pointer 70 within the operation detection area 15 can cause the moving image to be stopped, and can cause the operation by the pointer 70 to be performed in a state where the moving image is caused to be stopped. Furthermore, the performing of the operation of the pointer 70 outside of the operation detection area 15 can cause the operation by the pointer 70 to be performed without causing the moving image to be stopped. The setting of the operation detection area 15 based on the projection area 10 of the moving image that is projected onto the screen SC can cause the moving image to be stopped in a case where the operation of the pointer 70 is associated with the moving image.

With reference to FIG. 3, the range that results from adding or subtracting a predetermined value α or β to and from the coordinates of the four apexes of the projection area 10 that is detected by the position detection unit 242 is described as the operation detection area 15. However, the operation detection area 15 may be set in such a manner as to include one portion of the projection area 10, without the need to include all portions of the projection area 10. For example, the operation detection area 15 may be set in such a manner that the lower half or the upper half of the projection area 10 is included. For example, in a case where a child, such as an elementary school student, operates the pointer 70, and in a case where an adult, such as a teacher, operates the pointer 70, it can be changed whether the moving image is caused to be stopped.

Furthermore, the operation detection area 15 may be set in such a manner as not to include the projection area 10. For example, the moving image that is based on the moving image data may be projected onto the left side of the screen SC, and the right side of the screen SC may be set as the operation detection area 15.

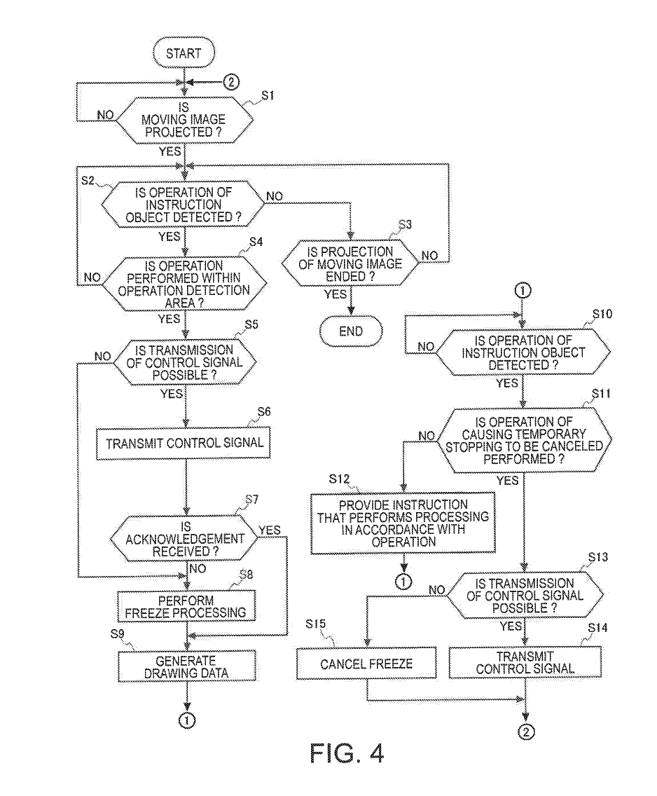

FIG. 4 is a flowchart illustrating operation of the projector 200.

The stop control unit 275 first determines whether or not the moving image that is based on the moving image data is projected onto the screen SC (Step S1). In the case of a negative determination (NO in Step S1), the stop control unit 275 waits until the moving image that is based on the moving image data starts to be projected. Furthermore, in the case of a positive determination (YES in Step S1), the stop control unit 275 determines whether or not the operation of the pointer 70 is detected by the pointer detection unit 240 (Step S2). The stop control unit 275 determines whether or not the coordinate information which indicates the operation position of the pointer 70 is input from the pointer detection unit 240, and determines whether or not the operation of the pointer 70 is detected (Step S2).

In a case where the determination in Step S2 is the negative determination (NO in Step S2), the stop control unit 275 determines whether or not the projection of the moving image onto the screen SC is ended (Step S3). In the case of the negative determination, that is, in a case where the projection of the moving image onto the screen SC is not ended (NO in Step S3), the stop control unit 275 returns to the determination in Step S2. Furthermore, in the case of the positive determination, that is, in a case where the projection of the moving image onto the screen SC is ended (YES in Step S3), the stop control unit 275 causes this processing flow to be ended.

Furthermore, in a case where the determination in Step S2 is the positive determination (YES in Step S2), the stop control unit 275 determines whether or not the operation position of the pointer 70, which is detected by the pointer detection unit 240, is located within the operation detection area 15 (Step S4).

In a case where the determination in Step S4 is the negative determination (NO in Step S4), the stop control unit 275 returns to the processing in Step S2, and waits until the operation of the pointer 70 is detected by the pointer detection unit 240. Furthermore, in the case of the positive determination (YES in Step S4), the stop control unit 275 determines whether or not the transmission of the control signal to the image supply apparatus 100 is possible (Step S5). The stop control unit 275 determines whether or not the I/F unit 251 through which the transmission of the control signal is possible is used for the connection to the image supply apparatus 100, and determines whether or not the transmission of the control signal to the image supply apparatus 100 is possible (Step S5).

In a case where the determination in Step S5 is the positive determination (YES in Step S5), the stop control unit 275 transmits the control signal that requests the image supply apparatus 100 to stop transmitting the image signal, to the image supply apparatus 100 (Step S6). Then, the stop control unit 275 waits until the acknowledgement of the control signal is received from the image supply apparatus 100. In a case where the acknowledgement is received within a predetermined time after the control signal is transmitted (YES in Step S7), the stop control unit 275 proceeds to processing in Step S9, and instructs the drawing processing unit 273 to generate the drawing data. Furthermore, in the case where the acknowledgement cannot be received within the predetermined time after the control signal is transmitted (NO in Step S7), the stop control unit 275 proceeds to processing in Step S8 and performs the freeze processing.

In a case where the determination in Step S5 is the negative determination (NO in Step S5), that is, in a case where the I/F unit 252 through which the control signal cannot be transmitted is used for the connection to the image supply apparatus 100, or in the case where the acknowledgement cannot be received within the predetermined time (NO in Step S7), the stop control unit 275 performs the freeze processing.

In a case where the freeze processing is performed in Step S8, the stop control unit 275 instructs the image processing unit 253 to stop performing the processing. Although the frame image data that constitutes the moving image data is input from the I/F unit 251, the image processing unit 253 that is instructed to stop performing the processing discards the frame image data without loading the frame image data onto the frame memory 255. While the freeze processing is performed, the frame image data that is supplied from the image supply apparatus 100 is not newly loaded on the frame memory 255, and the frame image data that has been loaded onto the frame memory 255 is projected, as the capture image, onto the screen SC.

Furthermore, when the freeze processing is performed in Step S8, or in a case where in the determination in Step S7, it is determined that the acknowledgement is received, the stop control unit 275 instructs the drawing processing unit 273 to generate the drawing data (Step S9).

The drawing processing unit 273 generates the drawing data and outputs the generated drawing data to the image compositing unit 257, and thus the drawing data is superimposed onto the frame image data that has been loaded onto the frame memory 255. The frame image data on which the drawing data is superimposed is processed, as the display image data, by the display unit 210, and the processed frame image data is projected onto the screen SC.

Next, the stop control unit 275 determines whether or not the operation of the pointer 70 is detected by the pointer detection unit 240 (Step S10). In the case of the negative determination (NO in Step S10), the stop control unit 275 waits until the operation of the pointer 70 is detected. Furthermore, in the case of the positive determination (YES in Step S10), the stop control unit 275 determines whether or not the detected operation of the pointer 70 is an operation that causes the temporary stopping of the moving image to be canceled (Step S11). For example, in a case where an icon for causing the temporary stopping of the moving image to be canceled is included in icons on the menu image 50, the stop control unit 275 determines whether or not the icon for causing the temporary stopping of the moving image to be canceled is selected. It is noted that the operation that is detected in Step S10 may be an operation on the operation panel 231 and that the determination in Step S11 may be an operation of determining whether or not input for the operation of causing the temporary stopping of the moving image to be canceled is received through the operation panel 231.

In a case where the detected operation of the pointer 70 is not the operation of causing the temporary stopping of the moving image to be canceled (NO in Step S11), the stop control unit 275 instructs another functional block (for example, the projection control unit 271, the drawing processing unit 273, or the data retention unit 274) that controls the performing of the processing, to perform processing that corresponds to the operation, input for which is received (Step S12).

Furthermore, in a case where the detected operation of the pointer 70 is the operation of causing the temporary stopping of the moving image to be canceled (YES in Step S11), in the same manner as with the determination in Step S5, the stop control unit 275 determines whether or not the transmission of the control signal to the image supply apparatus 100 is possible (Step S13). In the case of the positive determination (YES in Step S13), the stop control unit 275 transmits the control signal to the image supply apparatus 100 (Step S14), and causes the supply of the image signal to the image supply apparatus 100 to be resumed.

Furthermore, in the case of the negative determination (NO in Step S13), the stop control unit 275 instructs the image processing unit 253 to start the processing and causes the freeze processing to be canceled (Step S15). The image processing unit 253 that receives the instruction from the stop control unit 275 loads the frame image data, which is input from the I/F unit 251, onto the frame memory 255 for processing, and outputs the post-processing frame image data to the image compositing unit 257. The image compositing unit 257 loads the frame image data, which is input from the image processing unit 253, onto the frame memory 255, and outputs the loaded frame image data, as the display image data, to the optical modulation device drive unit 222.

Subsequently to the processing in Steps S14 and S15, the stop control unit 275 returns to the determination in Step S1, and determines whether or not the moving image that is based on the moving image data is projected onto the screen SC.

As described above, the projector 200 according to the first embodiment to which the display apparatus, the display system, and the control method for use in the display apparatus according to the invention are applied includes the display unit 210, the pointer detection unit 240, and the stop control unit 275. The display unit 210 projects the moving image that is based on the moving image data onto the screen SC. The pointer detection unit 240 detects the operation of the pointer 70 on the screen SC. In a case where the operation of the pointer 70 is detected by the pointer detection unit 240, the stop control unit 275 pauses the moving image that is projected onto the screen SC.

Therefore, operability in a case where the operation by the pointer 70 is performed on the moving image that is projected onto the screen SC can be elevated.

Furthermore, in a state where the moving image that is based on the moving image data is projected onto the screen SC, in the case where the operation of the pointer 70 is detected by the pointer detection unit 240, the stop control unit 275 pauses the moving image and causes the still image to be displayed on the screen SC.

Therefore, with the operation of the pointer 70, the moving image can be paused.

Furthermore, in a case where the operation of the pointer 70 is detected by the pointer detection unit 240, the stop control unit 275 generates the capture image, which results from capturing the moving image that is being projected onto the screen SC, and causes the generated capture image, as the still image, to be projected onto the screen SC.

Therefore, the capture image that is displayed on the screen SC when the operation of the pointer 70 is detected can be displayed as the still image.

Furthermore, the projector 200 includes the I/F unit 251 that performs communication with the image supply apparatus 100. In a case where the operation of the pointer 70 on the screen SC is detected by the pointer detection unit 240, the stop control unit 275 transmits the control signal that causes the transmission of the moving image data to be stopped, to the image supply apparatus 100.

Therefore, when the operation of the pointer 70 is detected, the control signal that causes the transmission of the moving image to be stopped is transmitted to the image supply apparatus 100. For this reason, the supply of the moving image data to the image supply apparatus 100 can be caused to be stopped. Thus, the moving image can be caused to be stopped and the still image can be caused to be displayed on the screen SC.

Furthermore, in a case where the acknowledgement of the control signal cannot be received from the image supply apparatus 100, the stop control unit 275 causes the image processing unit 253 to stop performing the processing and causes the still image to be displayed on the screen SC.

Therefore, in a case where the image supply apparatus 100 cannot be caused to stop the supply of the moving image data, the processing by the image processing unit 253 can be caused to be stopped and the still image can be caused to be displayed on the screen SC.

The stop control unit 275 generates the drawing image based on the operation of the pointer 70 that is detected by the pointer detection unit 240, and causes the generated drawing image to be displayed on the screen SC by the display unit 210. Therefore, with the operation of the pointer 70, the drawing image can be displayed on the screen SC.

Furthermore, the operation detection area 15 in which the operation of the pointer 70 is detected is set to be on the screen SC. The stop control unit 275 generates the drawing data based on the operation of the pointer 70 in the operation detection area 15, which is detected by the pointer detection unit 240, and projects the drawing image that is based on the generated drawing data, onto the screen SC.

Therefore, in a case where the operation of the pointer 70 is performed in the operation detection area 15, the drawing image that is based on the operation of the pointer 70 is displayed on the screen SC, and in a case where the operation of the pointer 70 is performed in an area other than the operation detection area 15, another operation can be performed by the pointer 70 without the drawing image being caused to be displayed on the screen SC.

Furthermore, based on the position on the screen SC, of the operation of the pointer 70 that is detected by the pointer detection unit 240, the stop control unit 275 determines whether or not the moving image that is displayed on the screen SC is caused to be stopped. In a case where it is determined that the moving image is stopped, the stop control unit 275 causes the moving image to be stopped and causes the still image to be displayed on the screen SC.

Therefore, the position on the screen SC, in which the operation by the pointer 70 is performed, is changed, and thus switching can take place between performing the operation by the pointer 70 without the moving image being caused to be stopped and performing the operation by the pointer 70 in a state where the moving image is caused to be stopped.

Furthermore, in a case where the operation position of the pointer 70, which is detected by the pointer detection unit 240, is located within a range that is set in advance from a projection position of the screen SC onto which the moving image is projected, the stop control unit 275 causes the image processing unit 253 to stop performing the processing.

Therefore, for example, in a case where the operation of the pointer 70 is performed near the projection position of the screen SC onto which the moving image is projected, it is possible that the moving image is caused to be stopped. Furthermore, in a case where the operation of the pointer 70 is performed in a position that is located away from the projection position of the screen SC onto which the moving image is projected, the operation by the pointer 70 can be performed without the moving image being caused to be stopped.

### Second Embodiment

A second embodiment is described with reference to the accompanying drawings.

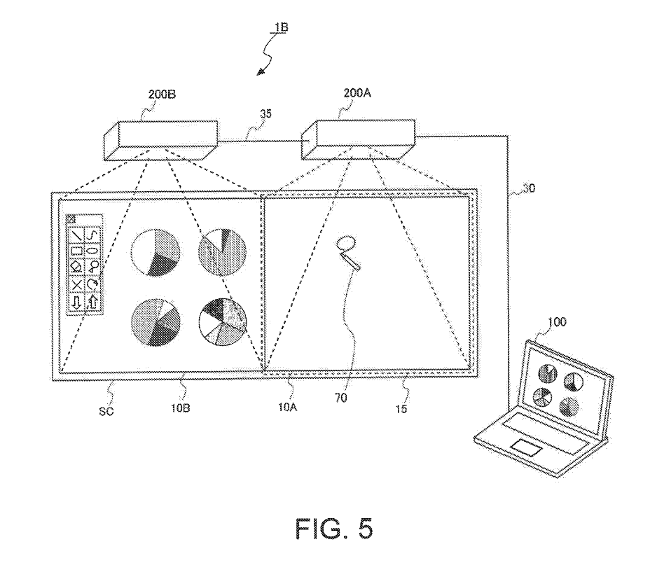

FIG. 5 is a configurational diagram illustrating a systematic configuration according to the second embodiment.

A display system 1B according to the present embodiment includes a projector 200A and a projector 200B. Because configurations of the projectors 200A and 200B are the same as the configuration of the projector 200 that is illustrated in FIG. 2, illustrations and descriptions thereof are omitted.

The projector 200A, for example, includes an HDMI input terminal and an HDMI output terminal (an illustration of any one of which is omitted), as the I/F units 251. The projector 200B, for example, includes an HDMI input terminal (an illustration of which is omitted), as the I/F unit 251.

The projector 200A and the projector 200B are cascade-connected to each other with a cable 35. The HDMI input terminal of the projector 200A is connected to the image supply apparatus 100 through the cable 30. Furthermore, the HDMI output terminal of the projector 200A and the HDMI input terminal of the projector 200B are connected to the cable 35.

According to an operation setting that is received by the operation panel 231, the projector 200A operates a first mode or a second mode.

In a case where the projector 200A is set to be in the first mode, the image signal that is input from the image supply apparatus 100 is processed in the projector 200A, without being output to the projector 200B. The projector 200A extracts the moving image data from the image signal that is input, for processing, and projects the moving image that is based on the moving image data, onto a projection area 10A of the screen SC.

Furthermore, when the projector 200A is set to be in the second mode, the image signal that is input from the image supply apparatus 100 is output to the projector 200B without being processed in the projector 200A. The projector 200B extracts the moving image data from the image signal that is input from the projector 200A, for processing, and projects the moving image that is based on the moving image data, onto a projection area 10B of the screen SC.

An operation mode for the projector 200A is described below as the second mode, and the projector 200A is described below as outputting the image signal that is supplied from the image supply apparatus 100, to the projector 200B. Furthermore, the projector 200A detects the operation of the pointer 70 that is performed in the projection area 10A, and performs processing that projects an image that corresponds to the detected operation to the projection area 10A.

In a case where the operation of the pointer 70 on the projection area 10A is detected by the pointer detection unit 240, the stop control unit 275 of the projector 200A determines whether the interface that is used for the connection to the image supply apparatus 100 is the I/F unit 251 or the I/F unit 252.

In a case where the I/F unit 251 through which the transmission and reception of the control signal is possible is used for the connection to the image supply apparatus 100, the stop control unit 275 of the projector 200A transmits the control signal to the image supply apparatus 100 and causes the supply of the image signal to be stopped.

When the supply of the image signal from the image supply apparatus 100 is stopped and the projector 200B causes the moving image, which is projected onto the projection area 10B of the screen SC, to be temporarily stopped, the projector 200A detects the operation of the pointer 70 and generates the drawing data that corresponds to the detected operation. Then, the projector 200A projects the drawing image that is based on the generated drawing data, onto the projection area 10A of the screen SC.

Furthermore, in a case where the I/F unit 252 through which the control signal cannot be transmitted and received is used for the connection to the image supply apparatus 100, the stop control unit 275 of the projector 200A transmits the control signal to the projector 200B, and causes the projector 200B to perform the freeze processing.

The projector 200B that is instructed by the projector 200A to perform the freeze processing instructs the image processing unit 253 of the projector 200B to stop performing the processing.

Although the frame image data is input, the image processing unit 253 of the projector 200B that is instructed to stop performing the processing discards the frame image data without loading the frame image data to the frame memory 255. While the freeze processing is performed, the frame image data that has been loaded onto the frame memory 255 is projected, as the capture screen, onto the projection area 10B of the screen SC.

In a case where the acknowledgement of the control signal is received from the projector 200B, the projector 200A detects the operation of the pointer 70, and generates the drawing data that corresponds to the detected operation. Then, the projector 200A projects the drawing image that is based on the generated drawing data, onto the projection area 10A of the screen SC.

In this manner, in the second embodiment, even in a case where different projectors 200 take charge of the projector 200A that detects the operation of the pointer 70 and the projector 200B that projects an image, respectively, in a case where the operation of the pointer 70 is detected, the moving image that is projected onto the screen SC can be caused to be stopped and thus the still image can be caused to be displayed.

In the second embodiment described above, the case where only the projector 200B projects the image is described, but both of the projector 200A and the projector 200B may project the image.

For example, the projector 200A and the projector 200B connect to different image supply apparatuses 100, respectively. The projector 200A and the projector 200B each process the image signal that is supplied from each image supply apparatus 100 and project the resulting image signal to the projection area 10A and the projection area 10B, respectively.

At this point, it is assumed that as an example, the image that is projected by the projector 200A is a still image, for example, an image (which is referred to as a document image) that is based on document image data which is generated by a word processor. Furthermore, it is assumed that the image that is projected by the projector 200B is a moving image, for example, a moving image that is based on moving image data that is generated by moving image reproduction software.

In a case where the operation of the pointer 70 on the projection area 10A is detected, the stop control unit 275 of the projector 200A instructs the projector 200B to stop the moving image. In the case where the I/F unit 251 through which the transmission and reception of the control signal is possible is used for the connection to the image supply apparatus 100, the projector 200B transmits the control signal to the image supply apparatus 100 and causes the supply of the image signal to be stopped. Furthermore, in a case where the I/F unit 252 through which the transmission and reception of the control signal is impossible is used for the connection to the image supply apparatus 100, the projector 200B performs the freeze processing.

When the projector 200B is instructed to stop an image, the stop control unit 275 of the projector 200A detects the operation of the pointer 70, and generates the drawing data that corresponds to the detected operation. Then, the projector 200A causes the drawing image, which is based on the generated drawing data, to be superimposed onto the document image that is projected onto the projection area 10A.

Furthermore, in a case where the pointer 70 or the operation panel 231 is operated and where an instruction that retains data is received, the data retention unit 274 acquires the display image data that is loaded on the frame memory 255 and causes the acquired display image data to be stored in the storage unit 260. That is, the data retention unit 274 acquires the image data, as the display image data, which results from superimposing the drawing data onto data of the document image that is projected onto the projection area 10A, and causes the acquired image data to be stored in the storage unit 260.

The first and second embodiments described above are suitable embodiments of the invention. However, no limitation to this is imposed, and various modifications to the embodiments are possible within a scope that does not depart the gist of the invention.

For example, in the embodiments described above, the operation detection area 15 is set based on the projection area 10 for a moving image, but the operation detection area 15 in which the operation of the pointer 70 is detected may be set independently of the projection area 10 for the moving image. Furthermore, in a case where without setting the operation detection area 15, the pointer 70 is detected from the entire captured-image data that is generated by the image capture unit 241, the drawing data may be generated based on the detected operation of the pointer 70, and the drawing image that is based on the generated drawing data may be projected onto the screen SC.

Furthermore, in a case where there is a great gap between a timing at which the operation of the pointer 70 is detected and a timing at which the image supply apparatus 100 causes the supply of the image signal to be stopped and causes the moving image to be stopped, at a time at which the control signal is output to the image supply apparatus 100, the stop control unit 275, for example, may be triggered to cause the display image data, which is loaded onto the frame memory 255, as the capture image, to be stored in the storage unit 260, at predetermined time intervals. In a case where a plurality of capture images are stored in the storage unit 260, the control unit 270 may cause the capture images to be projected onto the screen SC one after another, and may cause the capture image that is displayed on the screen SC to be selected by the user.

Furthermore, in the embodiments described above, the configuration in which, as the optical modulation device 212 that modulates light which is emitted by the optical source, the three liquid crystal panels that are of a light transmission type, which correspond to red, green and blue, respectively, are used, is taken an example for description, but the invention is not limited to this. For example, a configuration in which three liquid crystal panels that are of a light reflection type are used may be employed, and a technique that results from combining one liquid crystal panel and a color wheel may be used. Alternatively, a configuration may be employed in which a technique that uses three digital mirror devices (DMD), a DMD technique that results from combining one digital mirror device and a color wheel, or the like is used. In a case where as the optical modulation device, only one liquid crystal panel or the DMD is used, a member that is equivalent to the optical system for compositing, such as cross dichroic prism, is unnecessary. Furthermore, in addition to the liquid crystal and the DMD, any optical modulation device that is capable of modulating light that is emitted by the optical source can be employed without any problem.

Furthermore, each functional unit of the projector 200 that is illustrated in FIG. 2 illustrates a functional configuration, and no limitation to a specific form of mounting is particularly imposed. More precisely, a hardware item that individually corresponds to each functional unit does not necessarily need to be mounted, and of course, it is also possible that a configuration is employed in which the performing of program by one processor realizes functions of a plurality of functional units. Furthermore, in the embodiments described above, one or several of the functions that are realized in software may be realized in hardware. Alternatively, one or several of the functions that are realized in hardware may be realized in software. In addition, an arbitrary change to another specific detailed configuration of each unit of the projector 200 is also possible within a range that does not depart the gist of the invention.

Furthermore, units of processing in the flowchart that is illustrated in FIG. 3 result from division according to details of the processing for an easy understanding of the processing by the stop control unit 275 of the projector 200, and the invention is not limited by a method of division into the units for processing or the names of the units for processing. Furthermore, the processing by the stop control unit 275 can also be further divided into many units of processing according to the details of the processing, and one unit of processing can also be further divided to include many processing operations. Furthermore, the order of the processing operations in the flow described above is not limited to the example that is illustrated.

What is claimed is:

1. A display apparatus comprising:
a display unit that displays a moving image based on moving image data on a display surface;
an operation detection unit that detects operation of an pointer on the display surface; and
a control unit that pauses the moving image displayed by the display unit in a case where the operation detection unit detects the operation of the pointer.

2. The display apparatus according to claim 1,
wherein the control unit pauses the moving image and causes the display unit to display a still image, in a case where the operation detection unit detects the operation of the pointer, in a state where the display unit displays the moving image based on the moving image data.

3. The display apparatus according to claim 2,
wherein the control unit generates a still image that constitutes the moving image that is being displayed by the display unit, and causes the display unit to display the generated still image, in the case where the operation detection unit detects the operation of the pointer.

4. The display apparatus according to claim 1, further comprising:
an interface unit that performs communication with an external apparatus which supplies the moving image data to the display apparatus,
wherein the control unit transmits an instruction to pause the moving image data, via the interface unit, in the case where the operation detection unit detects the operation of the pointer.

5. The display apparatus according to claim 4,
wherein the control unit generates a still image that constitutes the moving image which is being displayed by the display unit and causes the display unit to display the generated still image, in a case where a response to the instruction to pause the moving image data is not received by the interface unit from the external apparatus.

6. The display apparatus according to claim 1,
wherein the control unit generates a drawing image based on the operation of the pointer that is detected by the operation detection unit, and causes the display unit to display the generated drawing image.

7. The display apparatus according to claim 6,
wherein a detection area is set on the display surface, the operation of the pointer is detected on the detection area, and
wherein the control unit generates the drawing image based on the operation of the pointer in the detection area, which is detected by the operation detection unit, and causes the display unit to display the generated drawing image.

8. The display apparatus according to claim 1,
wherein the control unit determines whether to pause the moving image, based on an operation position of the pointer that is detected by the operation detection unit.

9. The display apparatus according to claim 8,
wherein the control unit pause the moving image, in a case where the operation position of the pointer that is detected by the operation detection unit is located within a predetermined range that is set in an image area of the display surface on which the moving image is displayed.

10. A display system comprising:
a supply apparatus that supplies a moving image data; and
a display apparatus that displays a moving image based on the moving image data supplied from the supply apparatus,
wherein the display apparatus includes
a display unit that displays a moving image based on the moving image data on a display surface,
an operation detection unit that detects operation of an pointer on the display surface; and
a control unit that pauses the moving image displayed by the display unit, in a case where the operation detection unit detects the operation of the pointer.

11. A method of controlling a display apparatus that includes a display unit which displays an image on a display surface, the method comprising:
detecting operation of an pointer on the display surface, in a state where a moving image based on the moving image data is displayed on the display surface, and
pausing the moving image displayed by the display unit, in a case where the operation of the pointer is detected.

12. The method according to claim 11,
wherein pausing the moving image and displaying a still image by the display unit, in a case where the operation of the pointer is detected, in a state where the display unit displays the moving image based on the moving image data.

13. The method according to claim 12, further comprising:
generating a still image that constitutes the moving image that is being displayed by the display unit, and
displaying the generated still image by the display unit, in the case where the operation of the pointer is detected.

14. The method according to claim 11, further comprising:
transmitting to an external apparatus an instruction to pause the moving image data in the case where the operation of the pointer is detected, the external apparatus supplies the moving image data to the display apparatus.

15. The method according to claim 14, further comprising:
generating a still image that constitutes the moving image which is being displayed by the display unit and displaying the generated still image by the display unit, in a case where a response to the instruction to pause the moving image data is not received from the external apparatus.

16. The method according to claim 11, further comprising:
generating a drawing image based on the operation of the pointer that is detected; and
displaying the generated drawing image by the display unit.

17. The method according to claim 16,
wherein a detection area is set on the display surface, the operation of the pointer is detected on the detection area, and
generating the drawing image based on the operation of the pointer in the detection area; and
displaying the generated drawing image by the display unit.

18. The method according to claim 11, further comprising:
determining whether to pause the moving image, based on an operation position of the pointer that is detected.

19. The method according to claim 18,
pausing the moving image in a case where the operation position of the pointer that is detected is located within a predetermined range that is set in an image area of the display surface on which the moving image is displayed.
